(19) United States
(12) Patent Application Publication
(10) Pub. No.: US 2007/0152410 A1
(43) Pub. Date: Jul. 5, 2007

(54) SEAT LINER

(76) Inventors: Aaron Clark, Reynoldsburg, OH (US); Tom Gryniewicz, Park City, UT (US)

Correspondence Address: STANDLEY LAW GROUP LLP, 495 METRO PLACE SOUTH, SUITE 210, DUBLIN, OH, 43017, US

(21) Appl. No.: 11/306,585

(22) Filed: Jan. 3, 2006

(51) Int. Cl. B62D 39/00

(52) U.S. Cl. 280/33.992; 224/411

(57) ABSTRACT

A seat liner may be used in a shopping cart. The liner may be sufficiently resilient to maintain its shape. The liner may display advertisements. The liner may also be disposable and stackable.

### BACKGROUND AND SUMMARY OF THE INVENTION

The present invention is related to seat liners for shopping carts. More particularly the present invention is directed to a seat liner for a shopping cart that may be stackable, disposable and include advertisements.

While shopping, consumers may choose to buy more items than they are able to carry. This may happen often when shopping for groceries, but can also occur when shopping for clothing, household goods or other products. In the present application, retailer means any establishment that sells goods to consumers, including but not limited to, wholesalers, grocery stores, department stores, hardware stores, convenience stores, drug stores, electronics stores and any other specialty stores. To assist consumers, retailers may make carts available for consumer use. Carts may be maintained by retailers and used repeatedly by different consumers. Additionally, carts usually have child seats available for those consumers that may have small children. Children using the seats may come into contact with the same surfaces as consumers and other children. Since many different consumers and children may handle the carts from day to day, consumers may often be concerned with the spread of germs between other consumers and children. One method retailers may use to handle this concern may be to clean the carts periodically; however, this may not alleviate the problem entirely. Another option may be to make sanitary seat liners available to consumers free of charge. Alternatively, liners may be available for purchase by consumers directly.

Many different seat liners are known in the art. It has been known to make seat liners from a thin paper material, similar to tissue paper. Liners made of this material may be disposable. However, the material may make the liners difficult to install onto the cart and may require consumers to follow a series of complicated steps. Retailers may also have difficulty in getting consumers to use the thin paper liners because they lack an appealing or conspicuous display.

Other liners may be made from cloth or a quilted material. Consumers may purchase these liners, use them within the retail establishment and take them home to be washed. This allows consumers to reuse the liners and maintain control over the liners. These liners may not be practical for retailers because of their cost. Other known liners may not cover the entire seat or handle. Others may not fit more than one size of cart.

Retailers may also use carts for additional advertising exposure. Since many consumers may use carts from day to day, carts offer retailers many surfaces to display advertisements. Retailers may display advertisements on the front or sides of the cart itself. However, the consumer pushing the cart may not notice these advertisements since they are not directly in front of them.

Exemplary embodiments of the present invention may attempt to mitigate or solve many of these problems. The present invention is directed to a disposable seat liner which may have a base, at least one sidewall connected to the base, an aft wall connected to at least one sidewall and an advertisement disposed on a portion of the liner, where the liner is sufficiently resilient to maintain its shape. The liner may be sufficiently resilient to maintain its shape before and during use. The liner may also include a panel connected to the aft wall and a handle portion connected to the panel. A fore wall may also be connected to at least one sidewall. The fore wall may have an aperture which is adapted to receive a seat belt. A flap may be connected to and spaced apart from the sidewall and adapted to receive a portion of a shopping cart. The flap may allow the liner to be placed over different sized shopping carts. The advertisement may be a coupon which may be removable. The aft wall may have an aperture adapted to receive a leg of a person. In one embodiment the base, sidewall and aft wall are adapted to be sufficiently rigid to receive thereupon a second substantially similar disposable seat liner. The may allow one liner to be stacked onto a second substantially similar stackable seat liner.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates a front perspective view of an embodiment of the present invention.

FIG. 2 illustrates a top plan view of an embodiment of the present invention.

FIG. 3 illustrates a front elevation view of an embodiment of the present invention.

FIG. 4 illustrates a side elevation view of an embodiment of the present invention.

FIG. 5 illustrates a rear elevation view of an embodiment of the present invention.

FIG. 6 illustrates a rear perspective view of an embodiment of the present invention in place on a cart.

FIG. 7 illustrates a front perspective view of an embodiment of the present invention in place on a cart.

FIG. 8 illustrates a rear perspective view of an embodiment of the present invention in place on a cart.

FIG. 9 illustrates a top plan view of an unassembled embodiment of the present invention.

FIG. 10 illustrates a top perspective view of an assembled embodiment of the present invention.

### DETAILED DESCRIPTION

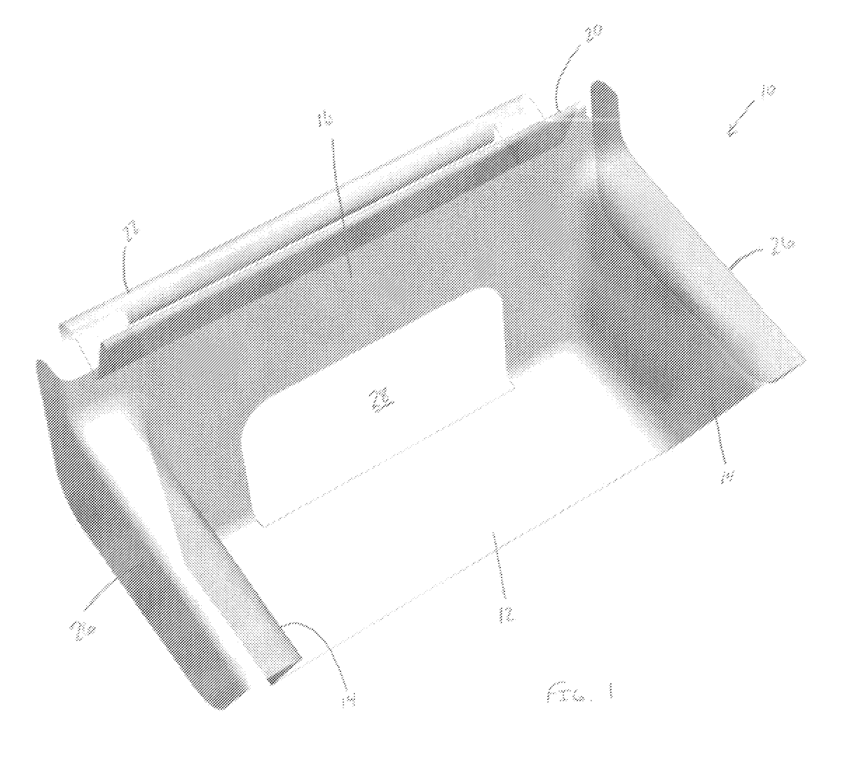

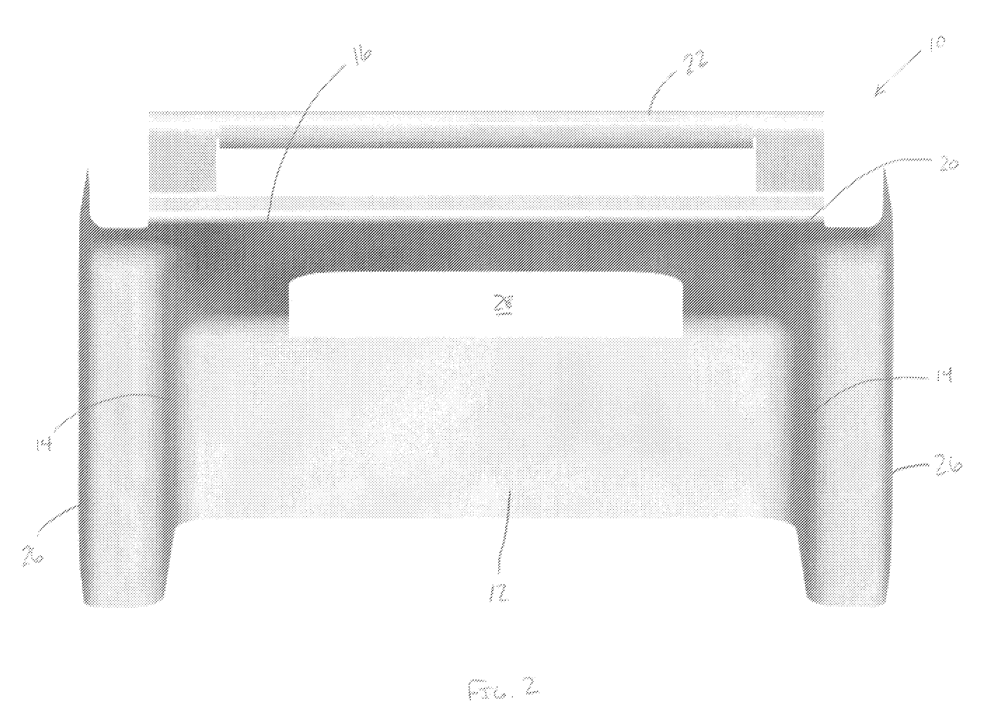

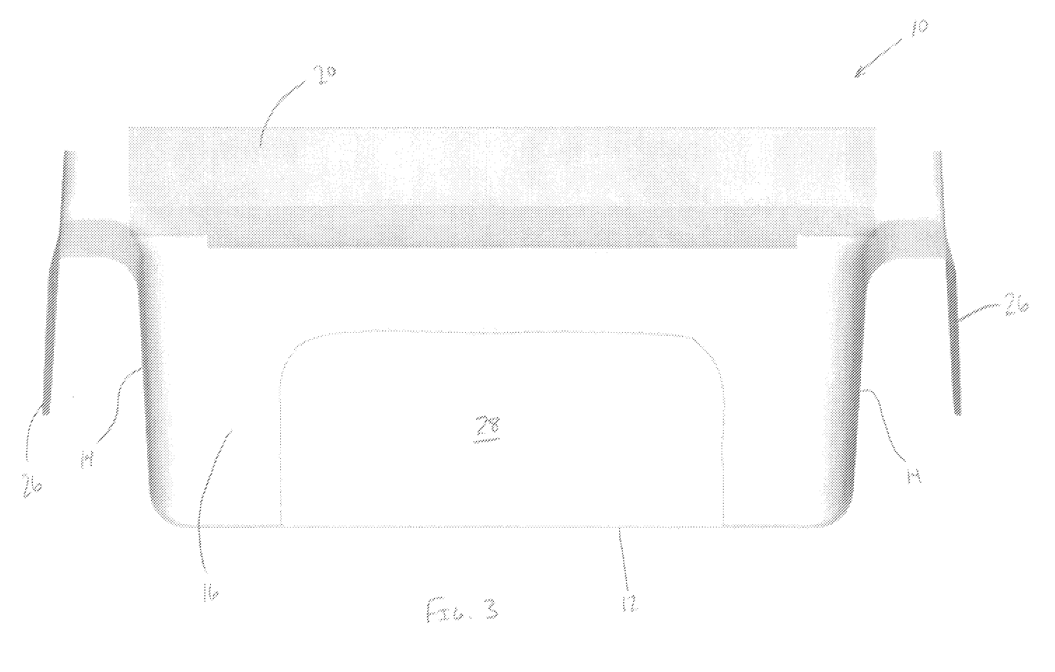

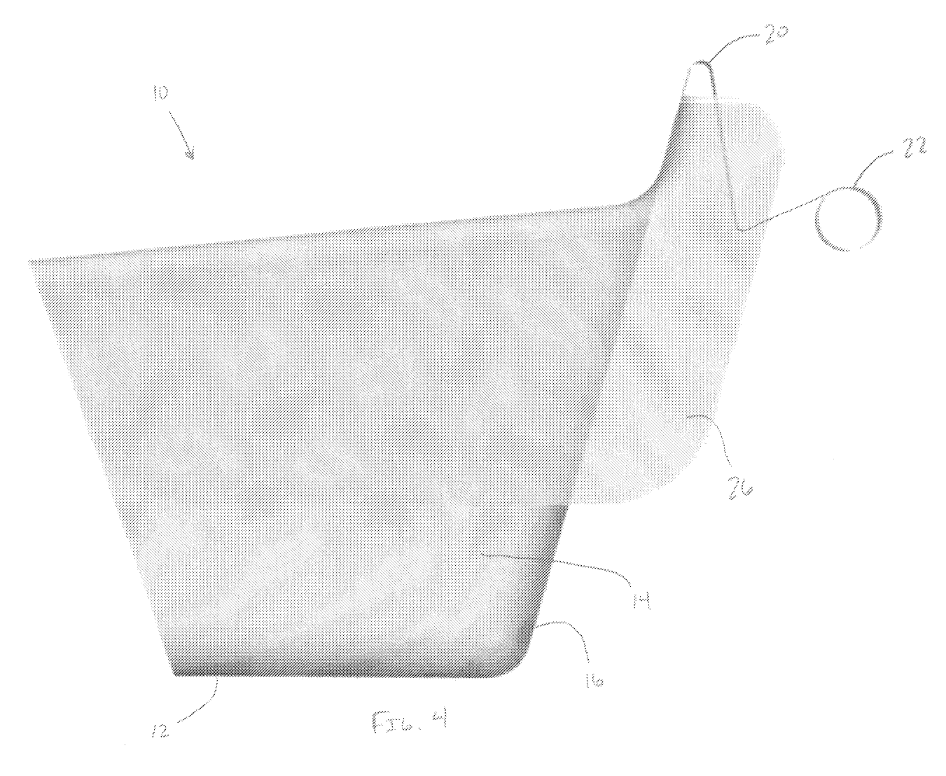

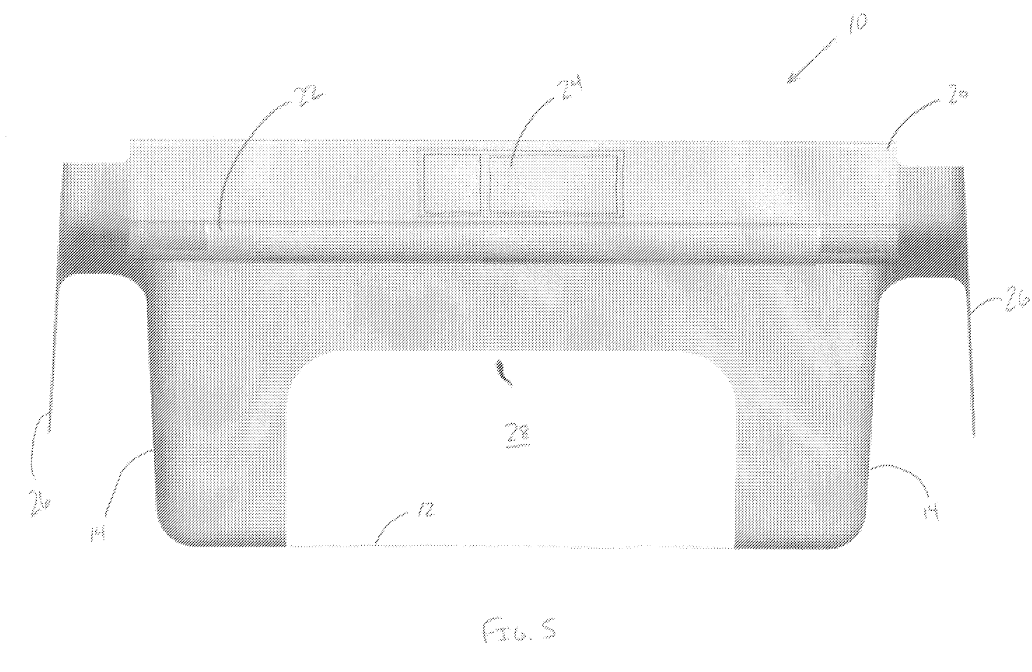

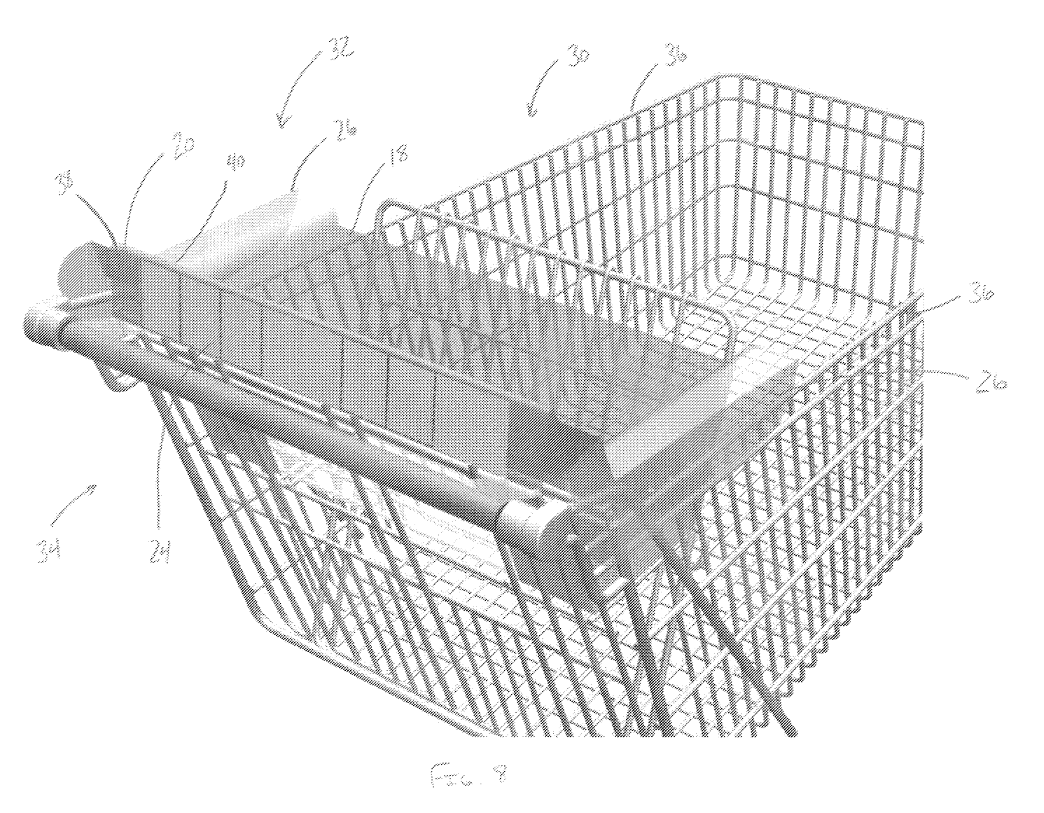

In the following embodiments, unless otherwise stated, the parts described may be interconnected in any manner known in the art. The term “connected” as used in the present application means formed integrally together as a single piece or connected together in a number of ways, such as with adhesives, fasteners, hinges and/or any combinations thereof. Any known adhesives, fasteners or hinges may be used. As shown in FIGS. 1-5, liner 10 may have a base 12. The upper surface of base 12 may be the surface on which a child sits. Liner 10 may also include sidewalls 14, aft wall 16 and optional fore wall 18 (shown in FIG. 8), which may define the remainder of the seat portion of liner 10. Liner 10 may also include panel 20. Panel 20 may be disposed between handle 22 and aft wall 16. In one embodiment, panel 20 may have an inverted ‘V’ shape.

Panel 20 may include advertisement 24. Advertisement 24 may be printed directly on panel 20. Advertisement 24 is not limited to being located on panel 20 but may be located on any portion of liner 10 and may include multiple advertisements. Advertisement 24 may also be removably attached to panel 24 in a number of ways. Panel 20 and advertisement 24 may be made of paper, which can be torn or cut from liner 10. Advertisement 24 may be adhesively attached to liner 10. Any adhesive may be used as long as advertisement 24 may be removed without substantially damaging advertisement 24. Other embodiments may include a spiral binding, punched holes in the advertisement attached to panel 20 with rings or perforations between each of the individual advertisements and/or panel 20. In any of these embodiments, a plurality of advertisements may be used and the advertisements may be “flipped” through like a book. Advertisement 24 may also be coupons, prize giveaways, fill-out cards for raffle drawings, or “scratch-off” game pieces.

Liner 10 may have handle 22 which may have a ‘C’ shaped cross section or may be large enough to wrap around itself to make a circle shaped cross section. Flaps 26 may extend and be spaced apart from sidewalls 14. Flaps 26 may allow liner 10 to be placed over different sizes of carts without requiring a new or different liner. Aft wall 16 may include aperture 28, which allows a person to place their legs through aft wall 16.

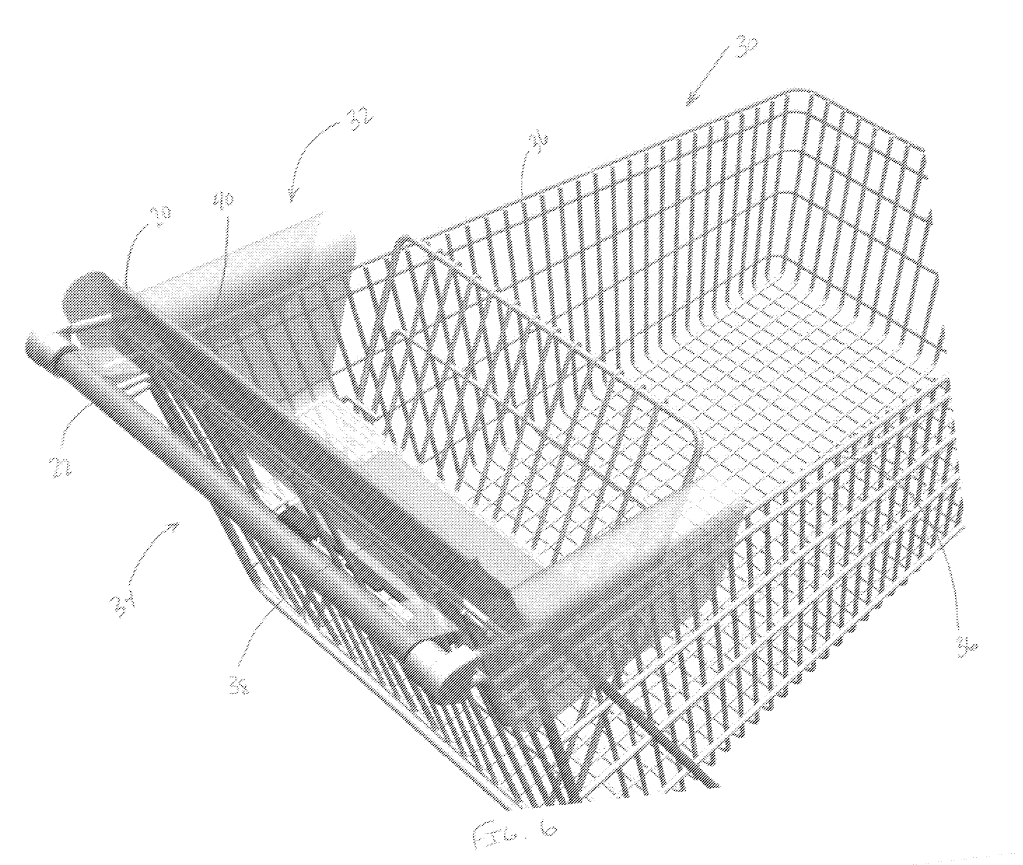

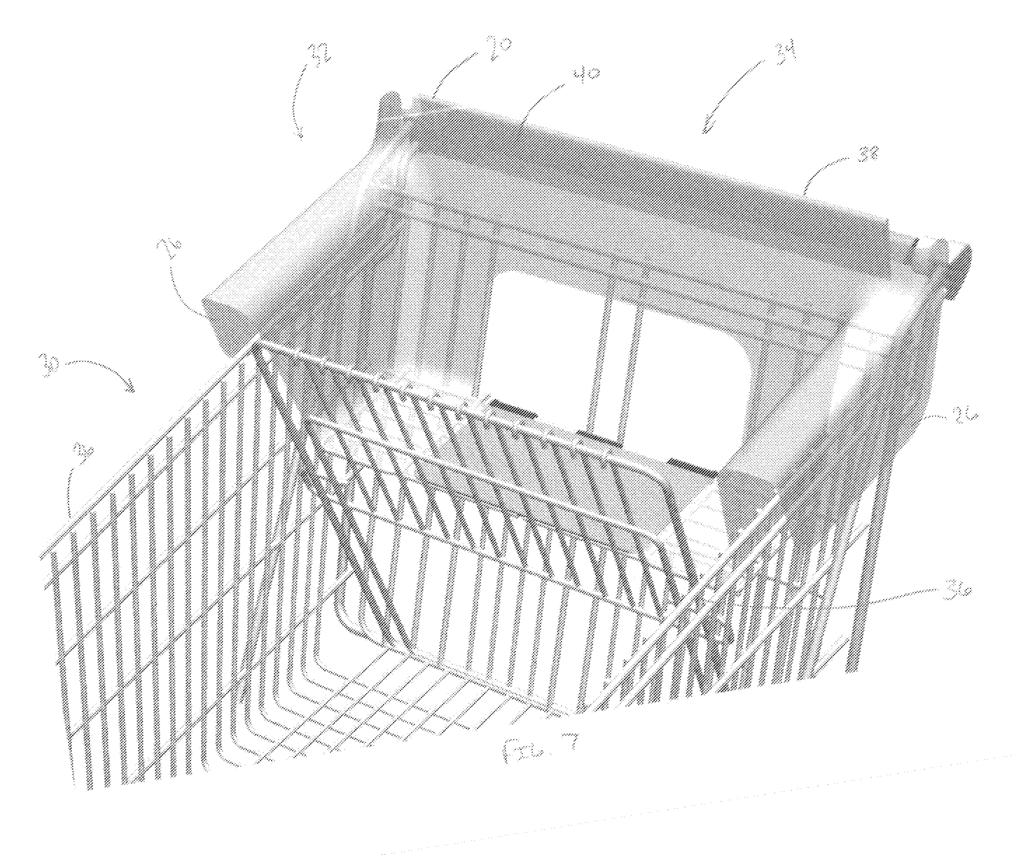

FIGS. 6-8 show embodiments of the present invention in use on cart 30. Cart 30 may include child seat portion 32, handle portion 34 and sides 36. Liner 10 may be placed over child seat portion 32 of cart 30. Base 12, sidewalls 14 and aft wall 16 may cover parts of child seat portion 32. Optional fore wall 18 may also be included to give additional coverage. Panel 20 and handle 22 may cover handle portion 34 of cart 30. Flaps 26 may extend over sides 36 of cart 30 to shield more portions of cart 30 where a child might be able to touch. The child may place his or her feet in aperture 28 and sit on the upper surface of base 12. In one embodiment, panel 18 may have advertisements on aft side 38 of panel 20 and pictures, puzzles or games for the child on fore side 40.

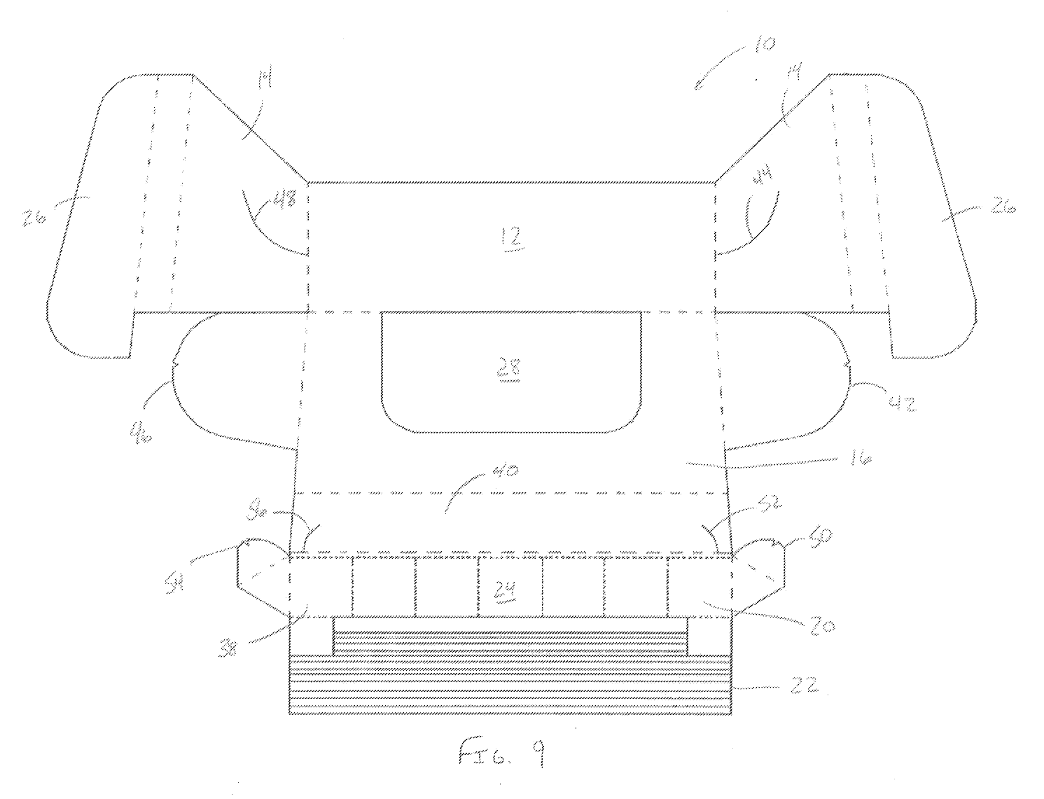

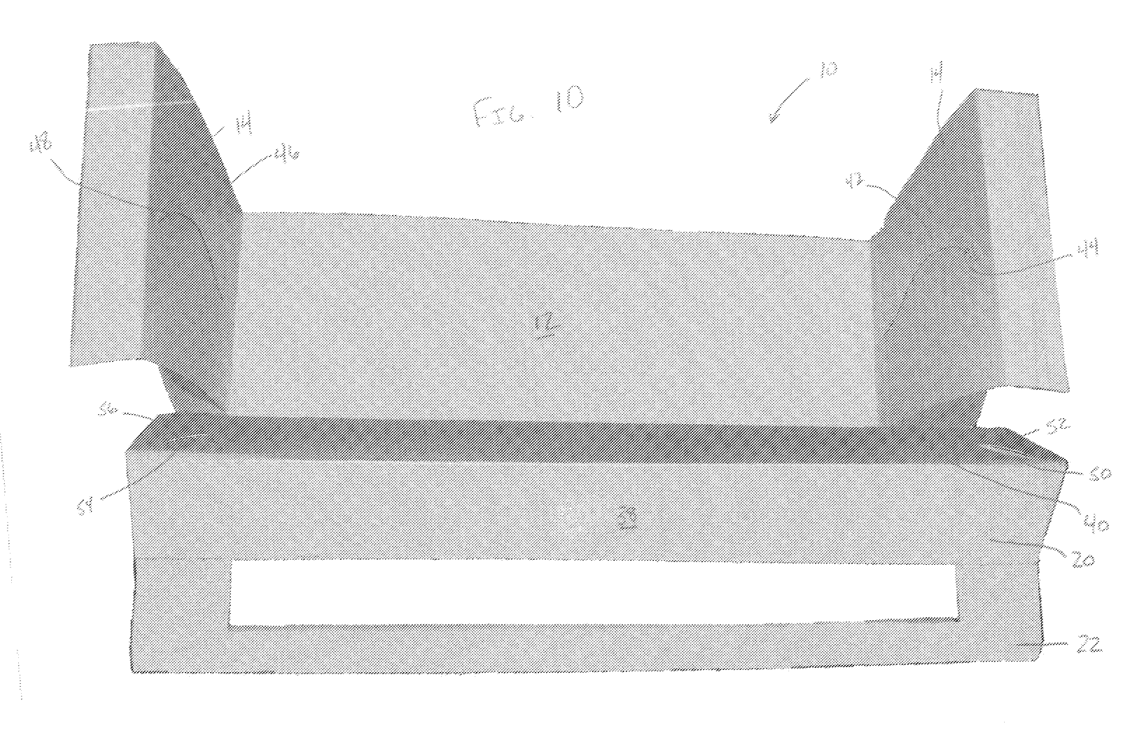

FIGS. 9 and 10 illustrate one embodiment of the present invention. Dashed lines in FIG. 9 may delineate fold lines for assembling liner 10. Liner 10 may be folded along each dashed line. Liner 10 may also include tabs 42, 46, 50 and 54, which are inserted into slots 44, 48, 52 and 56, respectively. Liner 10 may be completely assembled once all folds are made and tabs 42, 46, 50 and 54 are inserted into slots 44, 48, 52 and 56, respectively. FIG. 10 shows assembled liner 10.

Liner 10 may have the ability to be stacked so that one liner is placed on top or underneath a second liner. The top of one liner may be shaped in such a way to receive the bottom of another liner. Since liner 10 may be resilient, once a liner is removed from a stack of liners it may not lose its shape. This allows a consumer to easily remove a liner from the top of a stack of multiple liners and immediately place the liner over the cart without a series of complicated steps.

Liner 10 may be made from any material, which may be sufficiently resilient so that the liner's shape may be maintained before, during and/or after use. Examples of such materials include but are not limited to, paper, poster board, cardboard, plastic, wood, fiberglass, reinforced cloth, aluminum or any other metal, and/or combinations thereof.

While certain embodiments of the present invention are described in detail above, the scope of the invention is not to be considered limited by such disclosure, and modifications are possible without departing from the spirit of the invention as evidenced by the following claims:

What is claimed is:

1. A disposable seat liner comprising:
a base;
at least one sidewall connected to said base;
an aft wall connected to said at least one sidewall; and
an advertisement disposed on a portion of said liner;
wherein said liner is sufficiently resilient to maintain its shape.

2. The disposable seat liner of claim 1 wherein said liner is sufficiently resilient to maintain its shape before and during use.

3. The disposable seat liner of claim 1 further comprising:
a panel connected to said aft wall; and
a handle portion connected to said panel.

4. The disposable seat liner of claim 1 further comprising:
a fore wall connected to said at least one sidewall.

5. The disposable seat liner of claim 4 wherein said fore wall has disposed therein at least one aperture adapted to receive at least a portion of a seat belt.

6. The disposable seat liner of claim 1 further comprising:
a flap connected to and spaced apart from said at least one sidewall and adapted to receive a portion of a shopping cart.

7. The disposable seat liner of claim 6 wherein said flap is capable of being disposed over different sized shopping carts.

8. The disposable seat liner of claim 1 wherein said advertisement is a coupon and removably attached to said portion of said liner.

9. The disposable seat liner of claim 1 wherein said aft wall has disposed therein at least one aperture adapted to receive a leg of a person.

10. A disposable seat liner comprising:
a base;
at least one sidewall connected to said base; and
an aft wall connected to said base;
wherein said base, sidewall and aft wall are adapted to be sufficiently rigid to receive thereupon a second substantially similar disposable seat liner.

11. The disposable seat liner of claim 10 further comprising:
a panel connected to said aft wall and adapted to display at least one advertisement; and
a handle portion connected to said panel.

12. The disposable seat liner of claim 10 further comprising:
a fore wall connected to said base.

13. The disposable seat liner of claim 12 wherein said fore wall has disposed therein at least one aperture adapted to receive at least a portion of a seat belt.

14. The disposable seat liner of claim 10 further comprising:
a flap connected to and spaced apart from said at least one sidewall and adapted to receive a portion of a shopping cart.

15. The disposable seat liner of claim 14 wherein said flap is capable of being disposed over different sized shopping carts.

16. The disposable seat liner of claim 10 further comprising:
a panel connected to said aft wall and adapted to display at least one advertisement;
wherein said advertisement is a coupon and removably attached to said panel.

17. The disposable seat liner of claim 10 wherein said aft wall has disposed therein at least one aperture adapted to receive a leg of a person.

18. A stackable seat liner comprising:
a base;
a plurality of sidewalls connected to said base;
an aft wall connected to said plurality of sidewalls;
a handle portion connected to said aft wall; and
an advertisement disposed on a portion of said liner;
wherein said base, sidewall and aft wall are adapted to be stacked onto a second substantially similar stackable seat liner.

19. The stackable seat liner of claim 18 wherein said advertisement is a coupon and removably attached to said portion of said liner.

20. The stackable seat liner of claim 18 further comprising:
a fore wall connected to said plurality of sidewalls.
